(19) United States
(12) Patent Application Publication
(10) Pub. No.: US 2019/0288571 A1
(43) Pub. Date: Sep. 19, 2019

(54) ELECTRIC MOTORS FOR AIRCRAFT PROPULSION AND ASSOCIATED SYSTEMS AND METHODS

(71) Applicant: Wright Electric Inc., Cambridge, MA (US)

(72) Inventors: Antti Juhani Lehikoinen, Espoo (FI); Aaron Rowe, Toluca Lake, CA (US)

(21) Appl. No.: 16/280,652

(22) Filed: Feb. 20, 2019

Related U.S. Application Data
(60) Provisional application No. 62/632,599, filed on Feb. 20, 2018.

(51) Int. Cl. H02K 1/16; B64D 35/02; B64D 35/04; H02K 3/12; H02K 3/28; H02K 3/487; H02K 1/27

(52) U.S. Cl. CPC H02K 1/165; B64D 35/02; B64D 35/04; H02K 1/276; H02K 3/28; H02K 3/487; H02K 3/12

(57) ABSTRACT

An electric motor and associated systems and methods are described herein. A representative electric motor includes a stator having windings therein, wherein the stator has a diameter and a length greater than the diameter; and a rotor assembly inside the stator, wherein the rotor assembly includes a set of magnets configured to provide six or more poles.

### CROSS-REFERENCE TO RELATED APPLICATION

The present application claims priority to U.S. Provisional Application No. 62/632,599, filed on Feb. 20, 2018, and are incorporated herein by reference in its entirety.

### TECHNICAL FIELD

The present technology is directed generally to electric motors for providing propulsion for aircraft, and associated systems and methods.

### BACKGROUND

Electric motors convert electrical energy into mechanical work, via the production of torque. An electric motor can include a non-moving, roughly cylindrical stator. Inside the stator, the electric motor can include a rotor, also cylindrical, mounted on a rotating shaft. The stator and the rotor can be separated by an airgap. Electric power can be fed into the stator, while mechanical power can be extracted from the rotating rotor shaft. The power can be transferred over the airgap by the magnetic flux density, creating a torque acting on the rotor. An opposite-magnitude torque can also act on the stator.

Various designs of electric motors have been adopted to propel wheel-based vehicles (e.g., cars or trucks). However, since such electric motors are designed to power wheels, they are not well-suited to provide propulsion for aircraft. Accordingly, there remains a need in the industry for a viable and efficient electric motor that is designed to provide propulsion for aircraft.

### BRIEF DESCRIPTION OF THE DRAWINGS

FIG. 1A is a partially schematic, top view illustrating an aircraft including representative electric motors configured in accordance with some embodiments of the present technology.

FIG. 1B is a partially schematic illustration of a representative electric motor configured in accordance with some embodiments of the present technology.

FIG. 2 is a partially schematic, cross-sectional illustration of an electric motor shown in FIG. 1.

FIG. 3 is a partially schematic, cross-sectional illustration of an electric motor configured in accordance with some embodiments of the present technology.

FIG. 4 is a partially schematic, cross-sectional view taken along line A-A of FIG. 2, illustrating an electric motor configured in accordance with some embodiments of the present technology.

FIG. 5 is a partially schematic illustration of a magnet arrangement configured in accordance with some embodiments of the present technology.

FIG. 6 is a partially schematic, cross-sectional view taken along line A-A of FIG. 2 illustrating a representative rotor configured in accordance with some embodiments of the present technology.

FIG. 7 is a partially schematic, cross-sectional illustration of representative embedded magnets configured in accordance with some embodiments of the present technology.

FIG. 8 is a partially schematic, cross-sectional illustration taken along line A-A of FIG. 2, illustrating a representative stator configured in accordance with some embodiments of the present technology.

FIG. 9 is a partially schematic, cross-sectional view taken along line A-A of FIG. 2, illustrating a representative stator configured in accordance with some embodiments of the present technology.

FIG. 10A is a partially schematic, cross-sectional view of a stator portion a of FIG. 1B for a representative stator configured in accordance with some embodiments of the present technology.

FIG. 10B is a partially schematic, front view of an area 13 of FIG. 10A, illustrating a representative stator configured in accordance with some embodiments of the present technology.

FIG. 11A is a partially schematic, perspective view of a stator portion a of FIG. 1B for a representative stator configured in accordance with some embodiments of the present technology.

FIG. 11B is a partially schematic, front view of an area y of FIG. 11A, illustrating a representative stator configured in accordance with some embodiments of the present technology.

FIG. 11C is a partially schematic, front view of a portion of a representative stator configured in accordance with some embodiments of the present technology.

### DETAILED DESCRIPTION

### 1.0 Overview

The present technology is generally directed to electric motors for providing propulsion for aircraft, and associated systems and methods. In some embodiments, the electric motors power (e.g., rotate) propellers or fans, such as for direct-drive propulsion, instead of using a reduction gear. In particular embodiments, the electric motor can be a radial-flux AC machine (e.g., instead of an axial-flux motor). The electric motor can include a multi-phase winding in a stator, and an in-runner rotor (e.g., inside the stator) with permanent magnets (e.g., magnets with high remanence flux densities with a resistance to demagnetization, such as neodymium-based magnets or samarium-cobalt magnets). The stator and rotor cores can be formed from stacked electrical steel sheets.

In some embodiments, the electric motor can have a length-to-diameter ratio configured to limit the drag increase when attached to aircraft (e.g., for motors attached to or integral with aircraft wings, such as via placement within ducts, nacelles, engine pods, etc.). The length-to-diameter ratio can be configured in relation to a power-to-weight ratio of the electric motor. For example, the length can be greater than the diameter by a factor of 2.0, 3.0, or greater.

In some embodiments, the electric motor can include one or more additional bearings (e.g., in addition to bearings on opposing ends of the motor) spaced axially between opposing ends of the motor for reducing bending vibrations in the rotor (e.g., where the rotational frequency of the rotor corresponds to a critical bending frequency of the structure and/or material). Correspondingly, the rotor of the motor can be axially segmented into two or more segments. Each segment can have a core stack and permanent magnets. The segments can share a common solid shaft, or the shafts of neighboring segments can be connected to each other with flange joints.

In some embodiments, the electric motor can include permanent magnets mounted on the rotor surface and arranged to provide six or more poles (e.g., 10, 14, 16, 20, 22, or more poles), where a single pole-pair corresponds to a unique magnetic field or flux. For example, the permanent magnets can be embedded into the rotor surface. The use of six or more poles can increase the torque production capability of the motor, as the stator and rotor yokes can be thinner. Hence, the stator slot areas and the rotor diameter can be increased, both increasing the torque.

Further, the use of six or more poles can decrease the required height of the stator and rotor yokes, in turn enabling an increase in the rotor diameter while keeping the outer diameter constant (e.g., in comparison to turbogenerators that have 2 or 4 poles). Likewise, the ratio between the shaft diameter to rotor outer diameter can be increased. Besides increasing the torque capacity, this approach can also increase the bending stiffness of the rotor. Thus, for a fixed outer diameter, the electric motor with six or more poles can have a greater critical speed (e.g., a speed that corresponds to a first bending mode of the motor) than conventional turbogenerators.

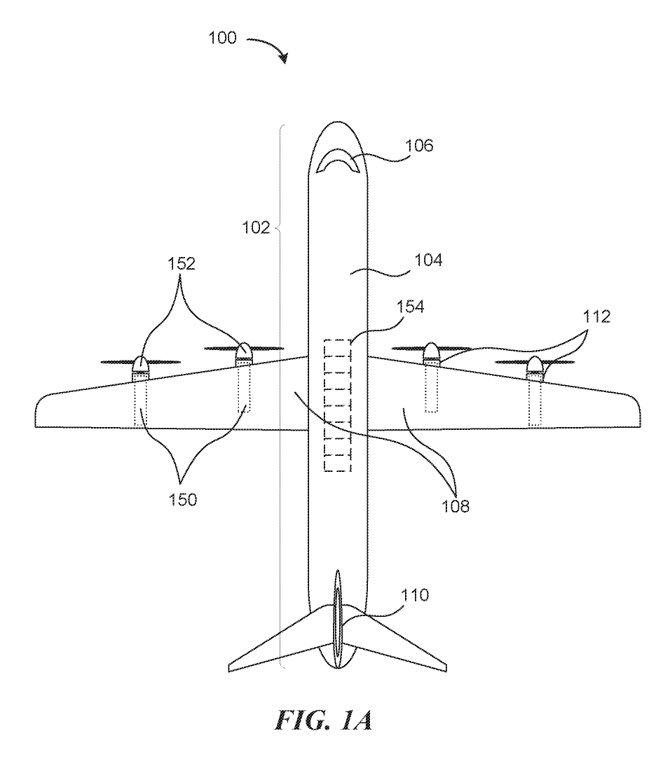

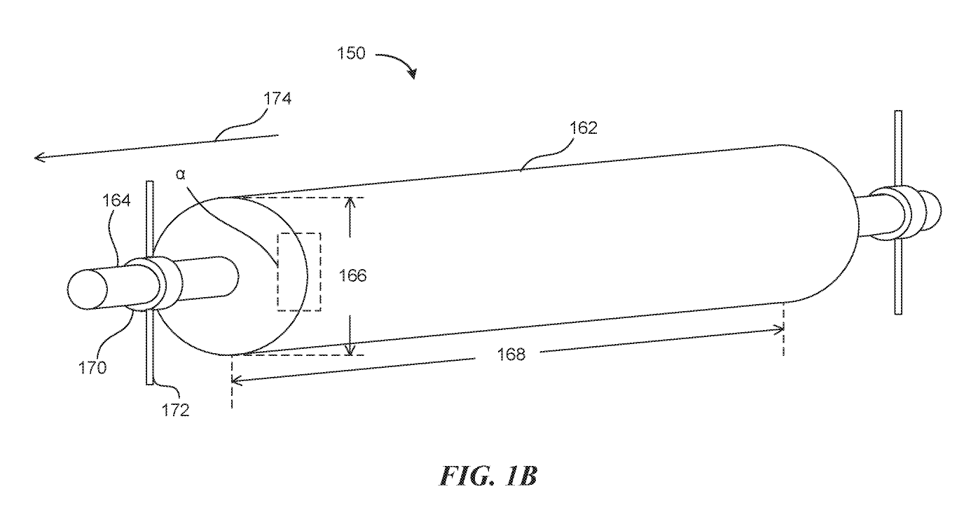

Specific details of representative embodiments of the present technology are described below with reference to selected configurations to provide a thorough understanding of these embodiments, with the understanding that the technology may be practiced in the context of other embodiments. Several details describing structures or processes that are well-known and often associated with electric motors and/or associated systems and components, but that may unnecessarily obscure some of the significant aspects of the present disclosure, are not set forth in the following description for purposes of clarity. Moreover, although the following disclosure sets forth some embodiments of different aspects of the technology, some other embodiments of the technology can have configurations and/or components that differ from those described in this section. As such, the technology may have other arrangements or configurations with additional elements and/or without several of the elements described below with reference to FIGS. 1A-11K.

For purposes of organization, the following discussion is divided into different sections, each dealing with a major electric motor component or system. It will be understood that aspects of the technology described in the context of a particular system or subsystem may be combined with other technology aspects described in the context of other subsystems, in any of a variety of suitable manners.

### 2.0 Overall Motor Configuration

FIG. 1A is a partially schematic, top view illustrating an aircraft 100 including representative electric motors 150 configured in accordance with some embodiments of the present technology. The aircraft 100 can include a fuselage 102, which can house a cabin 104 configured to carry a payload, such as a pilot, a passenger, an item (e.g., luggage, cargo item, etc.), or a combination thereof. In some embodiments, the fuselage 102 can further house a flight deck or a cockpit 106 that includes instrumentation and controllers configured to interface with operator(s) or pilot(s) riding within the flight deck/cockpit.

The aircraft 100 can include one or more sets of wings 108 configured to provide suitable lift for flight, takeoff, and landing. For example, the aircraft 100 can include different sets of wings for a monoplane configuration, a biplane configuration, etc. Also, the wings 108 can be shaped and/or located according to various configurations. For example, the wings 108 can be attached to or integral with the fuselage 102 according to configurations such as low/mid/high/shoulder/parasol wing configurations, unstaggered biplane or forward/backward stagger configurations, etc. Also for example, the wings 108 can be constant chord wings, tapered/trapezoidal wings, straight or swept wings, delta wings, etc. In addition to the lift-generating wings, the aircraft 100 can further include one or more control mechanisms, such as stabilizers 110 (e.g., vertical and/or horizontal stabilizers), flight control surfaces on the wings 108, etc., that provide for aircraft 100 stability and control.

The aircraft 100 can further include one or more electric motors 150 that are carried by the fuselage 102, such as through direct or indirect attachment or integration. For example, the electric motors 150 can be directly attached to/integral with the wings 108 or housings/nacelles 112 that are directly attached to/integral with the wings 108. Also for example, the electric motors 150 can be directly attached to/integral with the fuselage 102 or the nacelles 112 therein. The electric motors 150 can be configured to drive one or more propellers 152 to provide thrust using power from one or more batteries 154 in the aircraft 100. The electric motors 150 can use/convert the electric energy from the batteries 154 to rotate the propellers 152 that are attached to the electric motors 150.

FIG. 1B is a partially schematic illustration of a representative electric motor 150 configured in accordance with some embodiments of the present technology. The electric motor 150 can include a stator 162 (e.g., a stationary portion of a rotary system, such as the electric motor) coaxial with a shaft 164 (e.g., a rotating portion of a rotary system). Both the stator 162 and the shaft 164 can have a cylindrical shape. The stator 162 can surround and/or encompass at least a portion of the shaft 164. In particular embodiments, the stator 162 can include iron and/or another metallic material.

The stator 162 can have a diameter 166 and a length 168. In particular embodiments, the length 168 can be greater than the diameter 166 by a factor of 2.0 or greater (e.g., by a factor of 2.1, 3.0, 10.0 or any other suitable number greater than 2.0). Based on the relatively smaller diameter 166 (e.g., in comparison to the length 168), the electric motor 150 can reduce the drag on the corresponding aircraft 100 of FIG. 1A on which it is carried. Further, the relatively long length 168 (e.g., in comparison to the diameter 166) can produce the torque necessary to propel the corresponding aircraft 100 (e.g., because the torque production capability of an electric motor 150 is generally proportional to its volume).

In some embodiments, the shaft 164 can contact a bearing 170, e.g., carried by a support 172, at or near each opposing end of the electric motor 150. The bearing 170 can allow the shaft 164 to rotate in place, and can further provide support against gravitational forces.

The electric motor 150 can be configured to provide propulsion for the aircraft 100. For example, the shaft 164 can be connected to and rotate the propellers 152 of FIG. 1A (e.g., fixed or variable pitch propellers) that provide thrust along a direction 174 parallel to the length 168 of the electric motor 150. In some embodiments, the electric motor 150 can be placed in or integral with a pod, or the nacelle 112 of FIG. 1A. The electric motor 150 can be located at or integral with the nose/front portion of the fuselage and/or other locations/portions positioned away from the fuselage 102 of FIG. 1A (e.g., the wings 108, one or more stabilizers 110 of FIG. 1A, and/or other portions of the aircraft 100 extending away from the fuselage 102 or a portion of the fuselage 102).

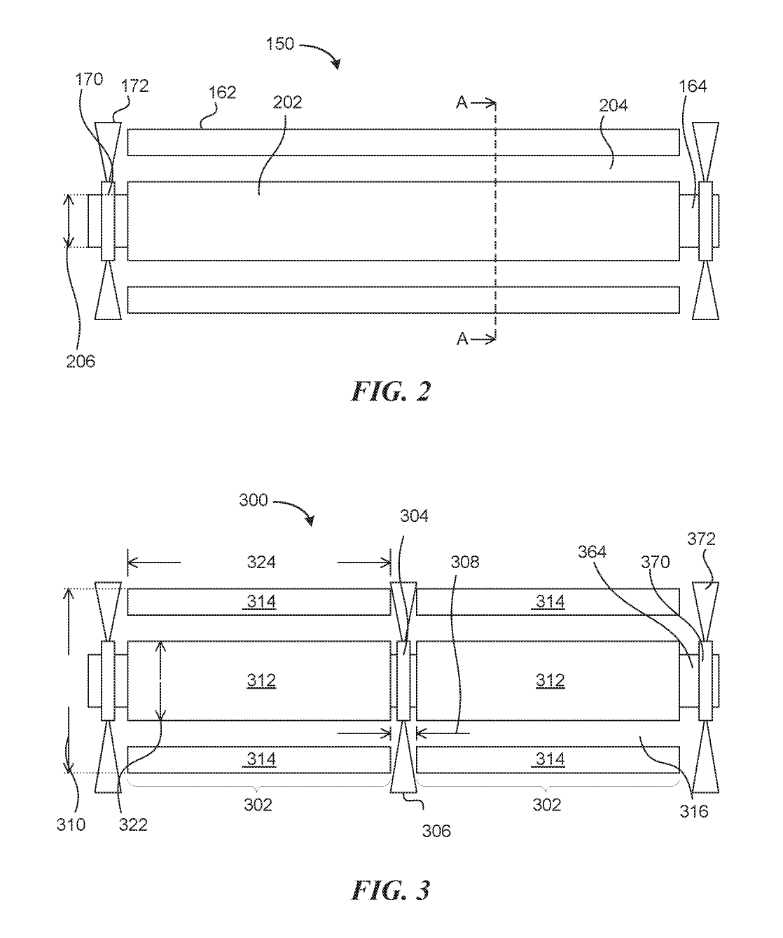

FIG. 2 is a partially schematic, cross-sectional illustration of a representative electric motor 150 shown in FIG. 1. Inside the stator 162, the shaft 164 can be connected to a rotor 202 mounted on the shaft 164. In particular embodiments, the rotor 202 can include iron and/or another metallic (e.g., ferrous) material. The rotor 202 and the stator 162 can be separated by an airgap 204.

The electric motor 150 can be a radial-flux AC machine that converts electrical energy into mechanical work (e.g., rotation of the shaft) based on producing torque. Electrical power can be provided to the stator 162 (e.g., to the windings of the stator 162), while mechanical power is extracted from the rotating rotor shaft 164 (e.g., based on a spatial relationship between the magnetic polarity of permanent magnets attached to or integral with the rotor 202, and the windings of the stator 162). The power can be transferred over the airgap 204 by magnetic flux density, which can create a torque acting on the rotor. An opposite-magnitude torque can also act on the stator 162.

Generally in the design of electric motors, the length-to-diameter (LID) ratio is limited by the bending vibrations of rotors therein (e.g., where the rotational frequencies of the rotors correspond to critical bending frequencies of the structures and/or materials). Specifically, the motor can be configured so as not to continuously operate at a rate/speed (e.g., revolutions-per-minute (rpm)) for which the rotational frequency (revolutions per second) corresponds to a critical bending frequency, without active control or some other kind of damping of the bending vibrations.

To reduce or prevent issues associated with bending vibrations, the electric motor can be limited to operation at a relatively low (e.g., between 500-5000 rpm) rotation rate that is below the first bending frequency that corresponds to the bending vibration. The electric motor can have a number of poles that provide the necessary amount of torque for the operating rpm range below the first bending frequency. Further, the increased number of poles can increase the length-to-diameter (UD) ratio.

Still further, the electric motor 150 can have a shaft thickness 206 that corresponds to a first bending frequency above the operating speed of the electric motor 150. Along with material make up (e.g., construction steel) selected for the shaft, the shaft thickness 206 can influence a bending frequency (e.g., a rotational frequency that causes vibrations) for the electric motor 150. For example, the shaft 164 can have a higher stiffness compared to the rotor stack, based on a shape, a size, and/or a geometry of the components, and/or based on the materials used for the components, which can influence the bending frequency. The shaft thickness 206 can be chosen to provide sufficient stiffness relative to the rotor stack 202, such that the first-occurring bending frequency is above the operating speed of the electric motor 150. Accordingly, the shaft thickness 206 can be chosen to increase the critical speeds of the electric motor 150.

FIG. 3 is a partially schematic, cross-sectional illustration of an electric motor 300 (e.g., an example of the electric motors 150 in FIG. 1A) configured in accordance with some embodiments of the present technology. The electric motor 300 can include two or more axial segments 302, with an exposed portion of a shaft 364 and an additional bearing 304 and/or an additional support structure 306 between the axial segments 302. The additional support structures 306 and/or the additional bearings 304 can be located between end bearings 370 and/or end supports 372 (e.g., structures similar to the bearings 170 of FIG. 1B and the supports 172 of FIG. 1B) that are located at opposite end portions of the electric motor 300. The additional support structures 306 and/or the additional bearings 304 can extend through an axial gap 308 between the axial segments 302 along a direction that is orthogonal to the overall length and parallel to a diameter of the electric motor 300. Further, the additional support structure 306 can reach between stator slots (not shown) to the shaft 364 and the additional bearing 304.

For illustrative purposes, FIG. 3 shows two axial segments 302 and one additional support 306. However, it is understood that the electric motor 300 can have any suitable number N of axial segments 302 (e.g., for n greater than or equal to 2) with one less additional support 306 (e.g., for n−1 number of additional supports).

Each of the axial segments 302 can include a rotor 312 mounted on the shaft 364 and a stator 314 surrounding the rotor 312. The stator 314 can be separated from the rotor 312 by an air gap 316. In some embodiments, the axial segments 302 can share a common shaft 364. In some embodiments, the shafts 364 of neighboring or adjacent segments can be connected to each other, such as with flange joints.

Further, each of the axial segments 302 can have a core stack (not shown) on the rotor 312, such as a structure that includes permanent magnets, a segment of the stator 314, etc. The stator assembly (e.g., the set of the stators 314) can include stator windings (not shown) configured to provide magnetic forces that interact with the core stack to provide rotational forces for the shaft 364. In some embodiments, the stator windings can extend axially through the entire stator assembly and remain unsegmented. Accordingly, the electric motor 300 can have two end-winding regions regardless of the total number of axial segments 302.

Each stator 314 can have the same stator diameter 310, and each rotor 312 can be the same rotor diameter 322 over the multiple axial segments 302 within the electric motor 300. Each of the axial segments 302 can further correspond to a segment length 324 that is less than the overall length of the electric motor 300. While increasing the overall length for a given diameter increases the torque provided by the electric motor 300, such as in relation to the L/D ratio, increasing the axial distance between support locations can lower the bending frequency. As such, segmenting the rotor 312 and placing the additional support 306 and/or the additional bearing 304 between the axial segments 302 can increase the torque and increase the L/D ratio without altering or lowering the bending frequency.

In some embodiments, the axial segments 302 can be skewed (e.g., with successive segments that are rotated or “clocked” relative to each other), such as for magnet placements. The skewed segments can improve the performance of the electric motor 300 based on reducing torque ripple.

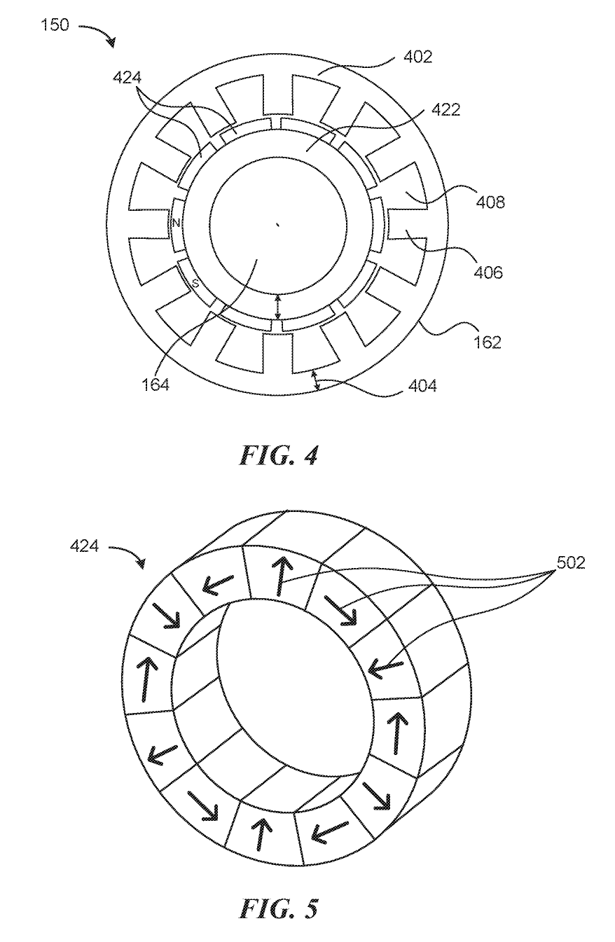

FIG. 4 is a partially schematic, cross-sectional illustration of an electric motor (e.g., an example of the electric motor 150 of FIG. 2) taken along a line A-A of FIG. 2. The partially schematic, cross-sectional illustration of FIG. 4 can also represent the electric motor 300 of FIG. 3, such as for illustrating the cross-section of one of the axial segments 302 of FIG. 2. The electric motor 150 can be a radial-flux AC machine that includes the stator 162 surrounding the rotor 202 and the shaft 164 as discussed above. In particular embodiments, the stator 162 and the rotor 202 can be formed from stacked electrical steel sheets, which can limit eddy-current losses for high electrical frequency. Special low-conductivity steel or an alloy with a high saturation flux density can be used, such as 0.1-0.2 mm low-loss SiFe alloy

The stator 162 can include a stator yoke 402 that includes a hollow cylinder-shaped structure with a cross-sectional shape of a ring. The stator yoke 402 can have a thickness 404 that is configured to carry the entire flux of one or more of the poles in the electric motor 150. The stator yoke 402 can include stator teeth 406 that extend in a radial direction (e.g., toward a center of the cylinder) from an inner wall of the stator yoke 402. The stator teeth 406 can be integral with the stator yoke 402 or be attached to the stator yoke 402. The stator 162 can further have stator slots 408 (e.g., a separation, a gap, or an empty space) between the stator teeth 406. The stator 162 can have one or more multi-phase windings (not shown) wrapped on the stator teeth 406. Accordingly, the windings can be in the stator slots 408.

The electric motor 300 can include the rotor 202 (e.g., an in-runner, such as a rotor that is inside the stator) that is encircled (e.g., along its length) by the stator yoke 402 and/or stacked (e.g., directly attached to and/or encircling) on the shaft 164 as discussed above. The rotor 202 can include a rotor yoke 422 surrounding the shaft 164. The rotor 202 can include magnets 424 attached on an outer surface of the rotor yoke 422. In particular embodiments, the rotor 202 can include electromagnets (e.g., such as for induction motor or a field-wound synchronous machine). In particular embodiments, the rotor 202 can include surface-mounted permanent magnets attached on the outer surface of the rotor yoke 422. In particular embodiments, the magnets 424 can be embedded into the rotor surface. The magnets 424 can be arranged such that the polarities of adjacent magnets 424 are different. For example, a first magnet can have a first polarity (e.g., magnetic “north”). The magnets immediately adjacent to the first magnet can have a second polarity (e.g., magnetic “south”). In some embodiments, for example, the magnetic polarity can alternate between the magnets 424 across a circumference of the rotor yoke 422.

The number of magnets 424 on the rotor 202 and/or the number of stator teeth 406 can correspond to a number of poles. The rotor 202 can include a relatively large number of magnets 424. For example, the high-strength permanent magnets can be configured to provide six or more poles (e.g., such as 10, 14, 16, 20, 22, or more poles). The large number of poles can increase the performance of the electric motor 150, which increases the performance of the aircraft 100 of FIG. 1A in which it is installed, by increasing the torque production capability of the motor. Based on the relatively large number of poles, the electric motor 150 can target/produce the same level of torque with a thinner (e.g., smaller diameter) stator 162 and rotor yokes 422. When thinner stator and rotor yokes are used, the electric motor 150 can be configured to increase stator slot areas and the rotor diameter, which can further increase the torque production.

When propelling the aircraft, the electric motor can generally operate in a relatively-narrow band (e.g., a band between 50%-100%) of speeds/rpm that are lower than the rated speed (i.e., highest speed at which the rated torque can be maintained). While the electric motor may operate at speeds above the rated speed, such speeds can be achieved based on weakening field strength, which lowers the torque output. Because the lowered torque output is undesirable in propelling aircraft, the magnetic circuit in electric aircraft motors can be designed without considering the field-weakening operation necessary to achieve speeds above the rated speed. Since there is no need to weaken the flux with the direct axis current, the airgap flux density can be relatively high, and the magnetizing inductance can be low.

### 3.0 Rotor Configuration

FIG. 5 is a partially schematic illustration of a magnet arrangement configured in accordance with some embodiments of the present technology. The magnets (e.g., the magnets 424) can be arranged so that magnetization directions 502 (e.g., polarities, a physical orientation, or a combination thereof for the magnets) are different along a circumference of the mounting surface. In some embodiments, the magnetization directions 502 can alternate according to a pattern as illustrated in FIG. 5. For example, the pattern can include a rotation or an angular offset of the magnetization directions 502 for adjacent magnets, an arrangement pattern relative to an exterior reference frame, and/or an arrangement pattern relative to an internal reference point (e.g., a center or the shaft 164 of FIG. 4). In one or more embodiments, the magnets 424 can be configured according to a Halbach array configuration. Alternating the magnetization direction can reduce the motor mass, or alternatively enable the use of a thicker shaft, increasing the rotor bending stiffness.

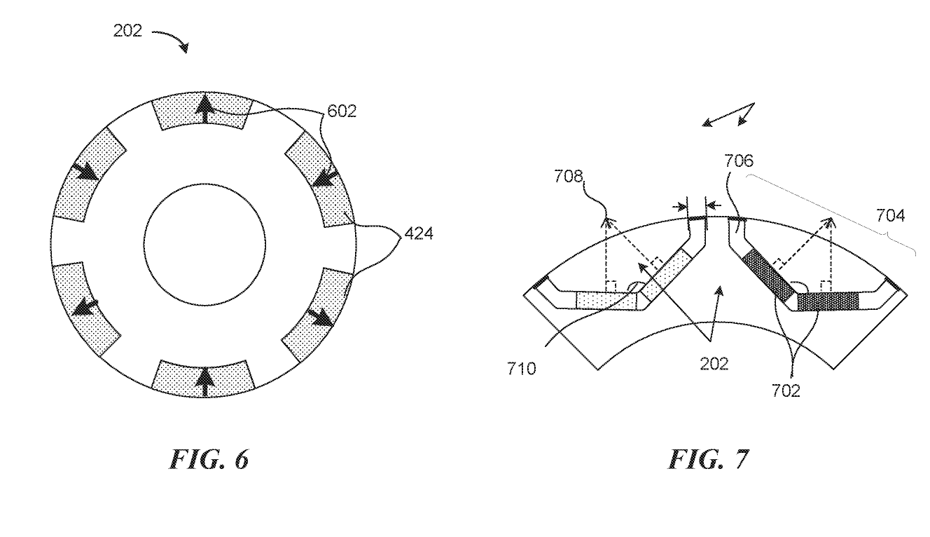

FIG. 6 is a partially schematic, cross-sectional illustration of a representative rotor (e.g., the rotor 202 of FIG. 2 and/or the rotor 312 of FIG. 3) taken along a line A-A of FIG. 2. In particular embodiments, the magnets 424 can be embedded in the rotor 202. The embedded magnets 424 can be configured so that magnetization directions 602 alternate and face opposite directions for adjacent magnets as illustrated in FIG. 6.

FIG. 7 is a partially schematic, cross-sectional illustration of representative embedded magnets 702 configured in accordance with some embodiments of the present technology. The embedded magnets 702 can be configured based on a flux focusing mechanism 704. For example, as illustrated in FIG. 7, the embedded magnets 702 can be placed in a saturation region 706. In the saturation region 706, a set of magnets (e.g., having two magnets as shown in FIG. 7) can be physically arranged to have a common focal point 708. In particular embodiments, the set of the embedded magnets 702 can be arranged to form an arrangement angle 710 that is less than 180 degrees, which in turn forms the magnetic focal point 708 beyond an outer surface of the rotor 202. The magnetic field of the embedded magnets 702 can be represented as a force (represented by a vector in FIG. 7) extending away from surfaces of the magnet along a direction orthogonal to such surfaces. Based on the arrangement angle 710, the magnetic fields of two or more magnets can overlap and provide increased effects/strengths at the magnetic focal point 708. Accordingly, the flux focusing mechanism 704 can increase the airgap field strength (e.g., the magnetic strengths across the airgap) and/or enable the use of weaker magnets to reach targeted torque levels by combining and increasing the magnetic field strengths at the magnetic focal points 708.

### 4.0 Stator Configuration

Representative electric motors, such as the electric motors illustrated in FIG. 2 and FIG. 3, can include a stator having a slotted design. The stator can include windings, such as windings corresponding to three or more phases. In particular embodiments, the windings or coils can be placed in the stator slots. For example, the stator can include a fractional-slot concentrated winding. Windings with all stator teeth wound, and alternate stator teeth wound, are both possible. In this configuration, the stator can have multiple open slots (e.g., 12, 18, or 24).

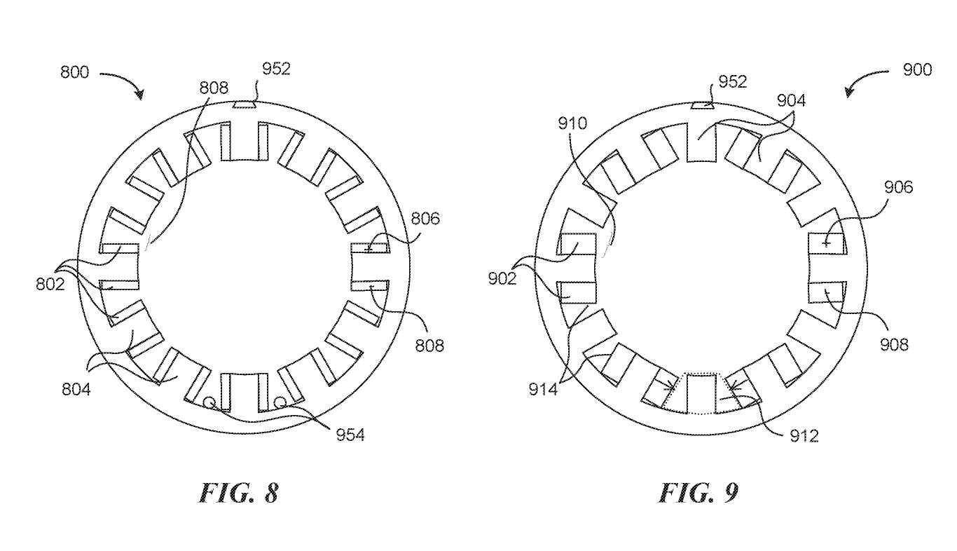

FIG. 8 is a partially schematic, cross-sectional illustration of a representative stator 800 (e.g., the stator 162 of FIG. 2 and/or the stator 314 of FIG. 3) taken along line A-A of FIG. 2. In particular embodiments, the stator 800 can include windings 802 on all stator teeth 804, such as for a 12-teeth stator configuration illustrated in FIG. 8. The windings 802 on opposing sides of each stator tooth can be of different or opposite magnetization directions 806. For example, a set of windings on one side of the stator tooth can have a magnetization direction corresponding to a positive orientation. A set of windings on the opposite side of the stator tooth can have an opposite or a negative magnetization direction. In other words, the stator 800 can include a set of windings (e.g., a pair of windings as illustrated in FIG. 8) within each stator slot 808 (e.g., a space between an adjacent set of the stator teeth 804) with different (e.g., opposite or offset) magnetization directions 806. Within one stator slot 808, a set of windings on one stator tooth can have a positive orientation/polarity and a set of windings on the opposing stator tooth of the stator slot can have a negative orientation/polarity.

FIG. 9 is a partially schematic, cross-sectional illustration of a representative stator 900 (e.g., the stator 162 of FIG. 2 and/or the stator 314 of FIG. 3) taken along line A-A of FIG. 2. The stator 900 can include windings 902 on alternating stator teeth 904, such as for a 12-teeth stator configuration as shown in FIG. 9. The windings 902 on the alternating stator teeth 904 can be of opposite magnetization directions. For example, the windings on one side of a given stator tooth can have a magnetization direction corresponding to a positive orientation 906. The windings on an opposite side of the stator tooth can have an opposite or a negative magnetization direction 908. Also, for example, the stator 900 can include one winding within each stator slot 910. The windings 902 within the stator slot 910 can have alternating or different magnetization direction across alternating adjacent stator slots.

In particular embodiments, a stator that includes the windings 902 on alternating teeth 904, such as illustrated in FIG. 9, can improve redundancy. According to the winding configurations, separation distances/spaces (e.g., separation space 912) between coil sides 914 belonging to different phases can be increased when the windings 902 are located on the alternating teeth 904. The increased separation can reduce the probability of an inter-phase short circuit.

For illustrative purposes, FIG. 8 and FIG. 9 are shown using a 12-teeth stator configuration. However, it is understood that the stator can have other numbers of stator teeth, other numbers of poles, or a combination thereof. For example, Table 1 below illustrates different stator teeth and/or pole configurations.

TABLE 1

| No. of stator teeth | No. of poles | Winding type/Notes |
|---|---|---|
| 12 | 10 | Alternate OR all teeth wound |
| 12 | 14 | Alternate OR all teeth wound |
| 18 | 16 | All teeth wound |
| 18 | 20 | All teeth wound |
| 24 | 22 | Alternate OR all teeth wound |
| 24 | 22 | Alternate OR all teeth wound, |
| | | six-phase configuration |

The stator winding can have several parallel paths per phase, up to the number of coils per phase. Each path can be supplied with an independent inverter, or an independent bridge in a multi-phase inverter. This can increase redundancy, and can be suitable for multi-phase (>3) operation.

Furthermore, the voltage induced in each path can be reduced, resulting in a higher number of turns per coil. This can enable the use of thinner wires/conductors, or eliminate the need for parallel sub-conductors (wires in hand/strands) in one path. Both of these factors can decrease the high-frequency AC losses in the winding, improving the machine efficiency.

In at least some embodiments, using form-wound (e.g., where the wire is square/rectangular and the turns are systematically arranged) tooth-wound coils can simplify the machine winding process. For tooth-wound coils, the positive and negative sides of a coil (e.g., +A and −A) can be located in the two slots immediately adjacent to a particular tooth. In contrast, a distributed winding can have one of the sides of a coil (e.g., +A) in one slot (e.g., slot 1), and the other side of the coil (e.g., −A) in another slot (e.g., slot 4) further away. Each coil can be first wound around a coil former, and then inserted into the stator core through the slot opening. The windings can be form-wound windings with conductors of rectangular cross-section. The tooth-coil concentric winding can be designed to have an increased self-inductance, even if the airgap length is relatively large (e.g., greater than 1-2 mm) compared to traditional designs. This will limit the induced short-circuit current in case of a coil or phase short-circuit, improving the reliability of the motor.

In some embodiments, the windings can include super-conductive material or ultra-conductive material (e.g., copper-composite material) to achieve a targeted power to weight ratio. Further, the improved conductive material in the windings can improve the thermal management by reducing the cooling requirements of the electric motor.

In some embodiments, as shown in FIGS. 8 and 9 the electric motor can include one or more core keys 952 (e.g., instead of an enclosing machine frame) that hold the stator core together. The core keys 952 can have an inverted-wedge-like cross-section, placed in dovetail-shaped slots in the stator core, on the stator yoke side. Axially, the core keys 952 can extend at least as far as the stator core. The core keys 952 can be connected to end-plates, providing axial compression to the stator core.

In some embodiments, the core keys 952 can be connected to a truss-like superstructure (not shown) comprising the machine frame. This superstructure can also support the bearings. The truss structure may or may not be an integral part of the aircraft structure.

In some embodiments, the electric motor can include or be attached to a cooling system, a portion of which is shown in FIG. 8. For example, the electric motor can be liquid-cooled using one or more cooling pipes 954 housed within one or more stator slots. In another example, the electric motor can include hollow conductors (e.g., separate cooling pipes within the separation space or hollow windings) with the coolant flowing inside. In still another example, the electric motor (e.g., the rotor) can be air-cooled.

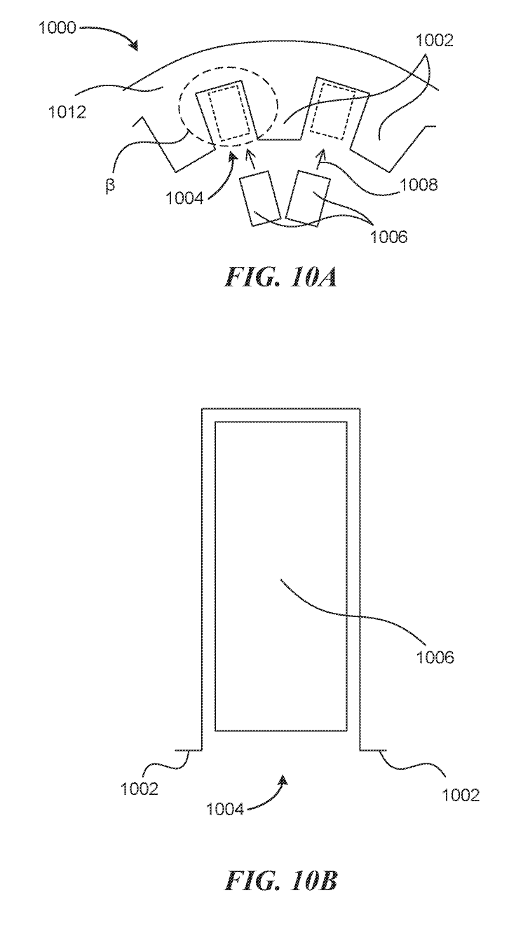

FIG. 10A is a partially schematic, cross-sectional view of a stator portion a of the system shown in FIG. 1B, illustrating a representative stator configured in accordance with some embodiments of the present technology. A stator 1000 can include stator teeth 1002 separated by and/or defining stator slots 1004. In some embodiments, adjacent pairs of the stator teeth 1002 can extend radially and/or parallel to each other, thereby forming the stator slots 1004 in between having a generally rectangular cross-sectional shape. In other embodiments, the stator teeth 1002 can extend radially toward a center portion of the stator 1000.

In manufacturing/assembling the stator 1000, a set of windings 1006 can be inserted into the stator slots 1004. The set of windings 1006 can be inserted along a radial direction 1008 from the center portion toward a corresponding stator yoke 1012. Once inserted, the windings 1006 can be adjacent to the stator teeth 1002 and/or within the stator yoke 1012.

FIG. 10B is a partially schematic, front view of an area 13 of FIG. 10A, illustrating a portion of a representative stator configured in accordance with some embodiments of the present technology. FIG. 10B illustrates a front view of the stator slot 1004 defined by a pair of the stator teeth 1002 and having a portion of the winding 1006 inserted therein. The stator slot 1004 can have an opening wider than a dimension of the winding 1006 such that the winding 1006 can be inserted into the stator slot 1004 through the opening.

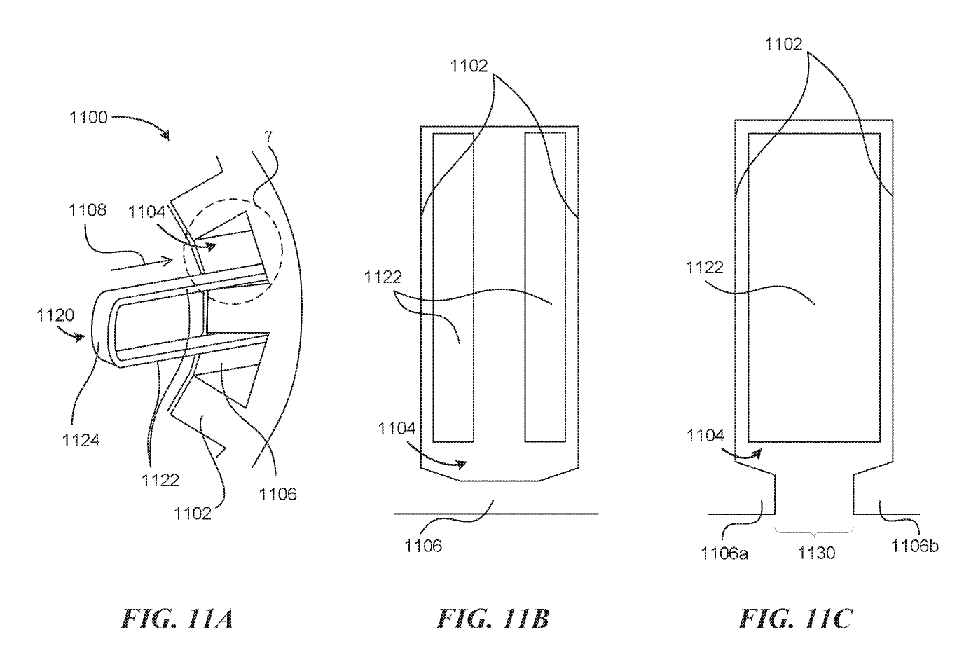

FIG. 11A is a partially schematic, perspective view of a stator portion a of FIG. 1B illustrating a representative stator configured in accordance with some embodiments of the present technology. A stator 1100 can include stator teeth 1102 separated by and/or defining stator slots 1104. In some embodiments, the stator 1100 can include a slot cover 1106 that connects and/or is integral with distal ends (i.e., relative to the stator yoke) of the stator teeth 1102. Accordingly, the stator slots 1104 can extend along the length 168 of FIG. 1 and/or the length 324 of FIG. 3 of the stator 1100 and can be generally enclosed by the slot cover 1106. For such configurations, the stator slots 1104 can have at least a pair of openings on opposing ends of the length of the stator 1100.

In manufacturing/assembling the stator 1100, U-shaped winding segments 1120 can be inserted into the stator slots 1104. The U-shaped winding segments 1120 can be inserted along an axial direction 1108 (i.e., parallel to the slot length). The U-shaped winding segments 1120 can include a pair of straight arms 1122 (e.g., active portions) joined by an end-winding portion 1124 (e.g., a bottom-curve portion of ‘U’ shape). When inserted, the straight arms 1122 can be adjacent to the stator teeth 1102 and/or within the stator yoke. After the winding segments 1120 are inserted, the ends of the U-shaped winding segments 1120 can be joined (e.g., electrically connected). In some embodiments, the U-shaped winding segments 1120 can be connected via inductive or laser welding.

As the winding is inserted along the axial direction 1108 (i.e., instead of the radial direction 1008 of FIG. 10A), fully closed or semi-closed slot openings can be used. FIG. 11B is a partially schematic, front view of an area y of FIG. 11A, illustrating a portion of a representative stator configured with fully closed slot openings in accordance with some embodiments of the present technology. FIG. 11C is a partially schematic, front view of a portion of a representative stator configured with semi-closed slot openings in accordance with some embodiments of the present technology. For illustrative purposes, FIG. 11B is shown with the winding configuration illustrated in FIG. 8, such that all stator teeth have windings thereon (i.e., with windings on opposing walls of the stator teeth defining a stator slot). Also, FIG. 11C is shown with the winding configuration illustrated in FIG. 9, such that alternating stator teeth have windings therein (i.e., with one set of windings occupying the stator slot).

For the fully closed slot openings, as illustrated in FIG. 11B for example, the slot cover 1106 can fully extend across the slot between adjacent stator teeth 1102 and enclose the stator slot 1104. The slot cover 1106 can be a barrier between the straight arm 1122 (i.e., the windings) and the rotor (not shown). For the semi-closed slot openings, as illustrated in FIG. 11C for example, the slot covers 1106 can partially extend between adjacent stator teeth 1102 and leave a tapered opening 1130. In some embodiments, a width of the tapered opening 1130 can be less than a width/thickness of the straight arm 1122 and partially cover the straight arm 1122 from the rotor. In other words, only portions of the windings may be exposed through the tapered opening 1130. The slot covers 1106 between the rotor assembly and the winding improves the motor performance by reducing the torque ripple. The slot covers 1106 further decrease the losses in the permanent magnets (by reducing the airgap flux ripple) and in the stator winding (by reducing eddy current losses caused by the airgap flux penetrating into the slot and linking parts of the winding). The slot covers 1106 can be made of or include ferromagnetic material, such as iron and/or another metallic material. In some embodiments, the slot covers 1106 can be made of or include same material as the stator teeth 1102.

In particular embodiments, the electric motor can be resilient to environmental factors, such as the reduced air pressure at typical aircraft flight altitudes, which can lead to a reduced critical electric field strength. To limit corona discharges (e.g., electrical discharge due to ionization of air surrounding electrically charged conductors), the end-winding can be designed in such a way that surfaces with a sharp curvature are avoided. Further, at typical altitudes, the motor will be subjected to cold ambient temperatures. This is taken into account in the design, as described below.

In one or more embodiments, the electric motor can be rated for 4 megawatts with a rated speed of 1500 rpm, and can have an axial length of 2-6 meters and an outer diameter greater than 1 centimeter and/or less than 1 meter. In some embodiments, a ratio between the axial length and the rotor diameter can be a number (e.g., about 18) that is much larger than other traditional motor designs, which have a ratio between 1-2 and/or a ratio between 7-9 for turbo-generators. In some embodiments, the electric motor disclosed herein can include 24 stator slots and 22 rotor poles, with fractional-slot concentric stator winding for alternate teeth winding configuration.

In another example, for an electric motor rated greater than 500 kW and/or less than 2 MW of shaft power with a rated speed of 800 rpm, the axial length can be 1-5 meters and the outer diameter can be 10-50 centimeters. The rotor aspect ratio can be between 15 and 20. The electric motor can include 12 to 24 stator slots and 10 to 24 rotor poles, with fractional-slot concentric stator winding for alternate teeth winding configuration.

An electric motor with the above-described features can be used to propel aircraft, including direct-drive operations for a fixed-wing aircraft (e.g., a short-haul propeller-driven aircraft with two or more motors). The high aspect ratio, with L/D being well above 1, instead of below 1, as is typical for road vehicle motors, results from the number of poles, the use of the permanent magnets on/in the rotor, the stator configuration, and/or a combination thereof. This high L/D ratio can reduce the air drag for the aircraft while it is in flight.

Further, as the length of the motor increases, the ratio between the end-winding length, which stays relatively constant, and the total coil length decreases. As the resistive winding losses are a significant contributor to the total losses, a proportionally shorter end-winding can yield an increase in the motor efficiency. Thus, increasing the length of the motor, such as to produce a high aspect ratio, can increase the motor efficiency by decreasing the ratio between the end-winding length to the total coil length.

Moreover, when configured for propelling aircraft, electric motors with one or more of the features described above can provide a relatively narrow (e.g., 500-3000 rpm range) speed envelope, precise controllability, and fast response times when compared to road-vehicle motors that have a very wide speed envelope, or servo motors that are configured to provide smooth torque. The power-rpm characteristics can be generally super-quadratic, which can be leveraged to yield an improvement in the efficiency around the maximum power region.

The foregoing description of the present technology is not intended to be exhaustive or to limit the disclosed technology to the precise forms disclosed above. While specific examples of the disclosed technology are described above for illustrative purposes, various equivalent modifications are possible within the scope of the disclosed technology, as those skilled in the relevant art will recognize.

While the Detailed Description describes certain examples of the disclosed technology, the disclosed technology can be practiced in multiple ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated.

From the foregoing, it will be appreciated that specific embodiments of the present technology have been described herein for purposes of illustration, but that various modifications may be made without deviating from the technology. For example, in some embodiments, the electric motor can include segments, as discussed above. In any of these embodiments, the general aspects of the aircraft can be similar to those described above so as to produce the operational efficiencies described above. For illustrative purposes, the embodiments above have been discussed with respect to application in fixed-wing aircrafts, however, it is understood that the various embodiments can be applied/utilized in other types of aircrafts (e.g., rotary wing aircrafts).

Certain aspects of the technology described in the context of particular embodiments may be combined or eliminated in other embodiments. For example, certain electric motor may include the overall configuration and features described above, but using electromagnets on/in the rotor instead of permanent magnets. Further, while advantages associated with certain embodiments of the technology have been described in the context of those embodiments, other embodiments may also exhibit such advantages, and not all embodiments need necessarily exhibit such advantages to fall within the scope of the present technology. Accordingly, the present disclosure and associated technology can encompass other embodiments not expressly shown or described herein.

The following examples provide additional embodiments of the disclosed technology.

In some embodiments, an electric motor (e.g., an axial-flux machine) can be configured to provide propulsion for an aircraft, and the electric motor can include: a stator assembly including: a stator yoke having a hollow cylindrical shape with a length and a diameter, wherein the length is greater than the diameter, stator teeth integral with the stator yoke, wherein individual stator teeth extend from an inner surface of the stator yoke toward a center line of the hollow cylindrical shape, stator windings attached to a set of the stator teeth, the stator windings configured to provide magnetic flux using electrical power; and a rotor assembly inside the hollow cylindrical stator yoke and having a length equal to or greater than the length of the stator, the rotor assembly including a set of magnets (e.g., permanent magnets) configured to provide six or more poles. In some embodiments, a ratio of the length of the stator yoke to the diameter of the stator can be 2.0 or greater.

In some embodiments, the stator windings of the electric motor can be configured for converting greater than 300 kilowatts of electrical power. In some embodiments, the stator assembly can include 12 or more stator teeth and the set of magnets can be configured to provide 10 or more poles.

In some embodiments, pairs of the stator windings can be attached to alternating stator teeth, where an individual pair of windings includes: a first winding portion attached to a first side of an individual stator tooth, the first winding corresponding to a first magnetization direction; and a second winding portion attached to a second, opposite side of the individual stator tooth, the second winding corresponding to a second magnetization direction opposite the first magnetization direction. In some embodiments, a pair the stator windings can be attached each of the stator teeth, wherein individual winding pairs include: a first winding attached to a first side of an individual stator tooth, the first winding corresponding to a first magnetization direction; and a second winding attached to a second side of the individual stator tooth that is opposite the first side of the individual stator tooth, the second winding corresponding to a second magnetization direction opposite the first magnetization direction. In some embodiments, the stator assembly can be a first stator assembly, the rotor assembly can be a first rotor assembly, where the motor further comprises: a shaft carrying the first rotor assembly and a second rotor assembly within the stator yoke of the first stator assembly and a stator yoke of a second stator assembly; and a support assembly positioned between the first and second stator assemblies and supporting the shaft.

In some embodiments, the stator assembly can further include a slot cover attached to or integral with an end of a stator tooth and extending in a direction orthogonal to a length of the stator tooth and toward an adjacent stator tooth, wherein the slot cover is between one of the stator windings and the rotor assembly, where the stator windings comprise U-shaped winding segments that are connected together. In one or more embodiments, the slot cover can be attached to or integral with the adjacent stator tooth and enclose the one of the stator windings between the stator tooth and the adjacent stator tooth. In one or more embodiments, the slot cover can be a first slot cover and the stator assembly can further include a second slot cover attached to or integral with an end of the adjacent stator tooth and having a shape mirroring the first slot cover, where the first slot cover and the second slot cover are separated by a tapered opening. In some embodiments, the tapered opening can be less than a width of the one stator winding.

In some embodiments, the magnets of the rotor assembly can be physically arranged to face the stator assembly with an orientation that is offset from radial directions. In one or more embodiments, the set of magnets can include embedded pairs of magnets, where each pair of magnets is physically arranged to form an arrangement angle that is less than 180 degrees and corresponds to magnetic focal points located beyond an outer surface of the rotor assembly. In one or more embodiments, the motor can include one or more cooling pipes attached to the stator yoke and between one or more adjacent pairs of the stator teeth.

In some embodiments, an aircraft can include: a fuselage configured to carry a payload; a wing; and a propulsion system that includes one or more electric motors carried by the fuselage and/or the wing, the one or more electric motors including: a stator assembly having a hollow cylindrical shape with a length and a diameter, wherein a ratio of the length to the diameter is 2.0 or greater, and a rotor assembly inside the hollow cylindrical shape of the stator, the rotor assembly including a set of magnets configured to provide six or more poles. In one or more embodiments, the one or more electric motors each includes a shaft, and the aircraft can further include a propeller connected to the shaft of each of the one or more electric motors; and an electric battery set operably coupled to each of the one or more electric motors, the electric battery set configured to store electric energy used to power the electric motors. In one or more embodiments, the electric motor can be configured to operate at a maximum speed of 800 revolutions-per-minute (rpm) or greater. In one or more embodiments, the electric motor can be configured to operate at an rpm within a range of 50% to 100% of the maximum speed.

I/We claim:

1. An electric motor configured to provide propulsion for an aircraft, the electric motor comprising:
a stator assembly including:
a stator yoke having a hollow cylindrical shape with a length and a diameter, wherein the length is greater than the diameter,
stator teeth integral with the stator yoke, wherein individual stator teeth extend from an inner surface of the stator yoke toward a center line of the hollow cylindrical shape,
stator windings attached to a set of the stator teeth, the stator windings configured to provide magnetic flux using electrical power; and
a rotor assembly inside the hollow cylindrical stator yoke and having a length equal to or greater than the length of the stator, the rotor assembly including a set of magnets configured to provide six or more poles.

2. The motor of claim 1, wherein the electric motor is an axial-flux machine.

3. The motor of claim 1, wherein the magnets in the rotor assembly are permanent magnets.

4. The motor of claim 1, wherein the stator windings are configured for converting greater than 300 kilowatts of electrical power.

5. The motor of claim 1, wherein:
the stator assembly includes 12 or more stator teeth; and
the set of magnets is configured to provide 10 or more poles.

6. The motor of claim 1, wherein a ratio of the length to the diameter of the stator is 2.0 or greater.

7. The motor of claim 1, wherein pairs of the stator windings are attached to alternating stator teeth, and wherein an individual pair of windings includes:
a first winding portion attached to a first side of an individual stator tooth, the first winding corresponding to a first magnetization direction; and
a second winding portion attached to a second, opposite side of the individual stator tooth, the second winding corresponding to a second magnetization direction opposite the first magnetization direction.

8. The motor of claim 1, wherein a pair the stator windings is attached each of the stator teeth, wherein individual winding pairs include:
a first winding attached to a first side of an individual stator tooth, the first winding corresponding to a first magnetization direction; and
a second winding attached to a second side of the individual stator tooth that is opposite the first side of the individual stator tooth, the second winding corresponding to a second magnetization direction opposite the first magnetization direction.

9. The motor of claim 1, wherein the stator assembly is a first stator assembly, the rotor assembly is a first rotor assembly, and wherein the motor further comprises:
a shaft carrying the first rotor assembly and a second rotor assembly within the stator yoke of the first stator assembly and a stator yoke of a second stator assembly; and
a support assembly positioned between the first and second stator assemblies and supporting the shaft.

10. The motor of claim 1, wherein the stator assembly further comprises:
a slot cover attached to or integral with an end of a stator tooth and extending in a direction orthogonal to a length of the stator tooth and toward an adjacent stator tooth, wherein the slot cover is between one of the stator windings and the rotor assembly; and
wherein:
the stator windings comprise U-shaped winding segments that are connected together.

11. The motor of claim 10, wherein the slot cover is attached to or integral with the adjacent stator tooth and encloses the one of the stator windings between the stator tooth and the adjacent stator tooth.

12. The motor of claim 10, wherein the slot cover is a first slot cover, and the stator assembly further comprises a second slot cover attached to or integral with an end of the adjacent stator tooth and having a shape mirroring the first slot cover, wherein the first slot cover and the second slot cover are separated by a tapered opening.

13. The motor of claim 12, wherein a width of the tapered opening is less than a width of the one stator winding.

14. The motor of claim 1, wherein the magnets of the rotor assembly are physically arranged to face the stator assembly with an orientation that is offset from radial directions.

15. The motor of claim 14, wherein the set of magnets includes embedded pairs of magnets, wherein each pair of magnets is physically arranged to form an arrangement angle that is less than 180 degrees and corresponds to magnetic focal points located beyond an outer surface of the rotor assembly.

16. The motor of claim 1, further comprising one or more cooling pipes attached to the stator yoke and between one or more adjacent pairs of the stator teeth.

17. An aircraft, comprising:
a fuselage configured to carry a payload;
a wing; and
a propulsion system that includes one or more electric motors carried by the fuselage and/or the wing, the one or more electric motors including:
a stator assembly having a hollow cylindrical shape with a length and a diameter, wherein a ratio of the length to the diameter is 2.0 or greater, and
a rotor assembly inside the hollow cylindrical shape of the stator, the rotor assembly including a set of magnets configured to provide six or more poles.

18. The aircraft of claim 17, wherein:
the one or more electric motors each includes a shaft and wherein the aircraft further comprises:
a propeller connected to the shaft of each of the one or more electric motors; and
an electric battery set operably coupled to each of the one or more electric motors, the electric battery set configured to store electric energy used to power the electric motors.

19. The aircraft of claim 17, wherein the electric motor is configured to operate at a maximum speed of 800 revolutions-per-minute (rpm) or greater.

20. The aircraft of claim 19, wherein the electric motor is configured to operate at an rpm within a range of 50% to 100% of the maximum speed.
